(19) United States
(12) Patent Application Publication
(10) Pub. No.: US 2023/0172236 A1
(43) Pub. Date: Jun. 8, 2023

(54) FRESH SEARED AND SOUS VIDE BATCH PROCESSING

(71) Applicant: Deli Star Inc., St. Louis, MO (US)

(72) Inventors: Justin Siegel, St. Louis, MO (US); Ganesh G. Kamath, Fayetteville, AR (US); Michael Shawn Weber, Columbia, IL (US)

(21) Appl. No.: 18/077,201

(22) Filed: Dec. 7, 2022

Related U.S. Application Data
(60) Provisional application No. 63/287,058, filed on Dec. 7, 2021.

(51) Int. Cl. A23L 5/10

(52) U.S. Cl. CPC A23L 5/13; A23L 5/17; A23L 5/15; A23V 2002/00; A23V 2300/20; A23V 2300/24

(57) ABSTRACT

A commercial-scale fresh sous vide cooking method includes searing food using infrared radiation, positioning the seared food in a water-impermeable package and vacuum sealing the water-impermeable package using a packaging machine, and positioning the vacuum-packaged food in a wet-steam cookhouse to fresh sous vide cook the food in the wet-steam cookhouse.

### CROSS-REFERENCE TO RELATED APPLICATION

This application claims the benefit of U.S. Provisional Application No. 63/287,058, filed on Dec. 7, 2021, which is hereby incorporated by reference in its entirety.

### FIELD

The present disclosure generally relates to methods and systems for food preparation.

### BACKGROUND

Foods prepared for commercial distribution are typically cooked to a sufficient temperature for killing off pathogens. However, the heat used to kill such pathogens also tends to drive out juices from the food, resulting in a product that is relatively dry and tough when reheated for serving after commercial storage and distribution. Sous vide cooking methods have been used to address this issue by putting food in a vacuum-sealed pouch and cooking the food in water at relatively low temperatures (e.g., less than 212° Fahrenheit) for relatively long periods of time. However, known efforts to do so on a wide commercial scale have been inefficient and/or limited to some degree. For example, some known sous vide solutions require a lot of water and/or energy to maintain, which can be expensive and/or eco-unfriendly. Other known sous vide solutions involve submerging the food in a water cascade system, but they cannot accommodate larger package sizes (e.g., larger than 5 pounds) due to the limited height of the water cascade.

### BRIEF SUMMARY

Examples described herein enable food to be cooked fresh sous vide on a commercial scale. In one aspect, a commercial-scale fresh sous vide cooking method is provided. The method includes searing food using infrared radiation, positioning the food in a water-impermeable package, vacuum sealing the water-impermeable package with the food positioned therein, and positioning the vacuum-packaged food in a wet-steam cookhouse to fresh sous vide cook the food.

In another aspect, a system for fresh sous vide cooking of food on a commercial scale is provided. The system includes an infrared oven configured to emit infrared radiation for searing the food, a packaging machine configured to position the food in a water-impermeable package and vacuum seam the water-impermeable package with the food positioned therein, a wet-steam cookhouse configured to fresh sous vide cook the food, and a control system for controlling one or more parameters associated with one or more of the infrared oven, the packaging machine, or the wet-steam cookhouse.

In yet another aspect, a control system is provided for use in controlling a fresh sous vide cooking system. The control system includes one or more sensors that detect one or more parameters associated with the fresh sous vide cooking system, and a controller that communicates with the one or more sensors to determine whether the one or more parameters satisfy a predetermined operational threshold and operate one or more of a tumbler, an infrared oven, a packaging machine, a truck, a wet-steam cookhouse, or a blast chiller based on the determination.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Additional features and advantages of one or more embodiments of the present disclosure will be set forth in the Detailed Description, and in part will be obvious from the Detailed Description or may be learned by the practice of such example embodiments.

### BRIEF DESCRIPTION OF THE DRAWINGS

This disclosure will be best understood by reference to the following Detailed Description when read in conjunction with the accompanying drawings, wherein:

FIG. 1 is a block diagram of an example fresh sous vide system;

FIG. 2 is a flowchart of an example method of a fresh sous vide process;

FIG. 3 is perspective view of an example truck that may be used to implement the sous vide process shown in FIG. 2;

FIG. 4 is a block diagram of an example control system for controlling the operation of a system, such as the fresh sous vide system shown in FIG. 1; and

FIG. 5 is a block diagram of an example computing system that may be used to perform one or more computing operations.

Like parts are marked throughout the drawings, as well as throughout the Detailed Disclosure, with the same reference numerals. The drawings are for the purpose of illustration and description only and are not intended to define the scope of the claimed subject matter. The drawings are not necessarily drawn to scale, and certain drawings may be shown in exaggerated or generalized form in the interest of clarity and conciseness. Although specific features may be shown in some of the drawings and not in others, this is for convenience only. In accordance with the examples described herein, any feature of a drawing may be referenced and/or claimed in combination with any feature of any other drawing.

### DETAILED DESCRIPTION

The subject matter described herein is directed to new and non-obvious sous vide cooking methods and systems for creating various food products that are superior in taste, texture, and appearance in a sustainable manner. The food products also have improved food safety, food quality, and shelf-life. Examples described herein include a “Fresh Sous Vide” process that involves searing food using infrared heat, vacuum sealing the seared food in a water-impermeable, food-grade package, and cooking the vacuum-sealed food in a wet-steam cookhouse using controlled heating.

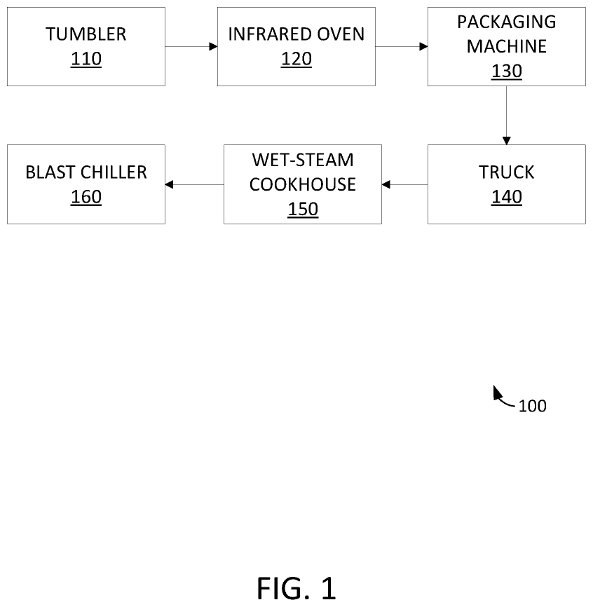

Referring now to the drawings, which are provided for purposes of illustrating one or more examples and not for purposes of limiting the same, an example fresh sous vide system 100 is shown at FIG. 1. In some examples, the system 100 is commercial-scale and can process 4,000-6,000 pounds of food per hour. As shown in FIG. 1, the system 100 may include a vacuum tumbler 110, an infrared oven 120, a packaging machine 130, a truck 140, a wet-steam cookhouse 150, and/or a blast chiller 160.

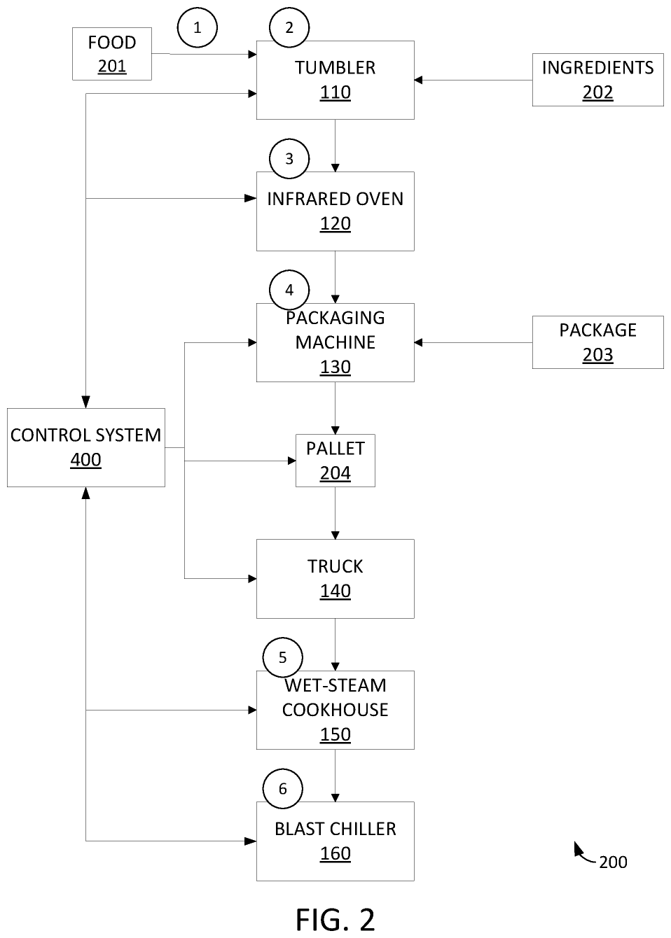

FIG. 2 shows an example method 200 of a fresh sous vide process that may be employed using the system 100. Fresh raw food 201 (e.g., meat, seafood, vegetables, plant-based products) is received at operation 1 and mixed with ingredients 202 (e.g., water, oil, salt, etc.) in the tumbler 110 at operation 2. The fresh raw food 201 that is received at operation 1 is never frozen. Unlike other sous vide processes, the method 200 described herein does not process frozen or thawed, i.e., previously-frozen, food. The food 201 may be whole, sized, slice, diced, shredded, etc.

The food 201 is seared using the infrared oven 120 at operation 3. The infrared oven 120 may include a plurality of heat emitters configured to emit infrared radiation for searing, browning, or otherwise conditioning an exterior of the food 201 to help lock in the juices of the food 201 and achieve a desired exterior, texture, and/or appearance in an energy-efficient manner. The infrared oven 120 may include a plurality of reflectors configured to reflect radiant heat, providing a thermo-resonance effect that allows the power of infrared radiation to be redistributed and equalized over the food 201. For example, the infrared radiation emitted and/or reflected towards the food may have a temperature of at least 500 degrees Fahrenheit. In some examples, the infrared oven 120 is a horizontal infrared tunnel oven designed for industrial production processes. For example, the infrared oven 120 may be configured to provide rapid heat treatment applications in a continuous conveyer production using uniform radiant heating. An example infrared oven 120 is an INFRABAKER oven. (INFRABAKER is a registered trademark owned by Wegra Beheer B.V. in Nieuwendijk, The Netherlands).

The food 201 is portioned in batches and placed into a water-impermeable package 203, which is vacuum sealed using a packaging machine 130 at operation 4. Batching the food 201 with other like foods allows for more control and/or flexibility in creating tailored cooking conditions. For example, a longer cook time may be used for larger muscle cuts of beef and pork. Creating tailored cooking conditions also allows for enhancing product attributes of lower-priced muscle cuts and yields lower-cost finished products. Moreover, the vacuum seal prevents evaporative losses of flavor, nutrients, and moisture during cooking and inhibits off-flavors from oxidation. Prior to vacuum sealing the package 203, the packaging machine 130 may reduce an amount of air entrapped inside the package 203 to enable a more-efficient transfer and control of thermal energy to the food 201 therein. The package 203 may be fabricated from one or more food-grade plastic materials with a relatively low oxygen transmission rate or OTR (e.g., less than 0.0338 fluid ounces per 100 square inches per day) and a relatively low moisture vapor transmission rate or MVTR (e.g., less than 0.0000645 grams per 100 square inches per day). The packages 203 may be various sizes ranging from 8-ounce packs to 15-pound packs. In some examples, the package 203 includes a rigid or semi-rigid cup, tray, or container and a flexible top. An example packaging machine 130 is a MULTIVAC machine. (MULTIVAC is a registered trademark owned by MULTIVAC Sepp Haggenmüller SE & Co. KG in Wolfertschwenden, Germany).

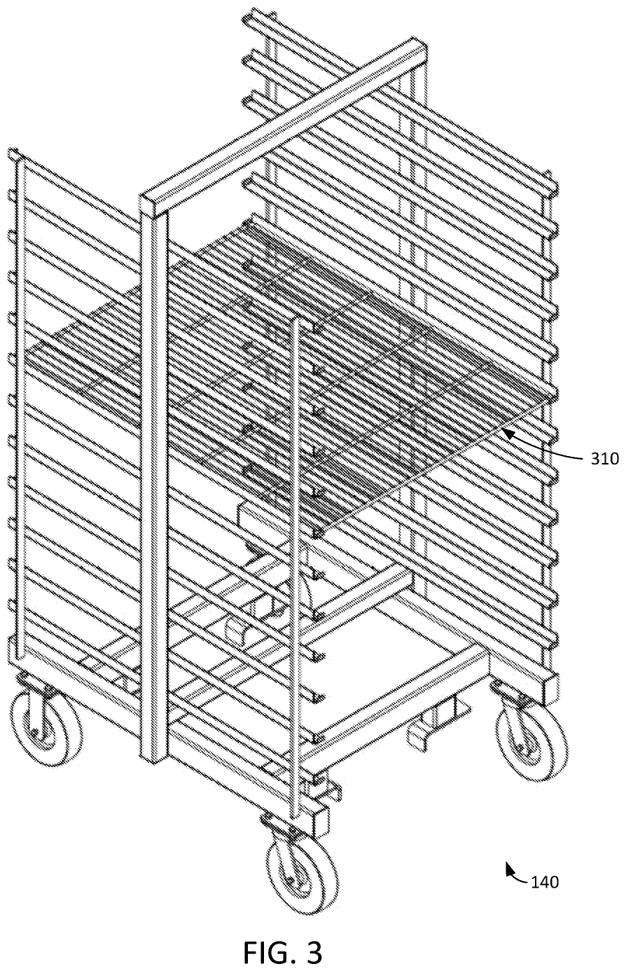

The packaging machine 130 positions one or more packages 203 on a pallet 204 and one or more pallets 204 on a truck 140 or trolley configured to carry the food 201 on the pallets 204. FIG. 3 shows an example truck 140. The truck 140 may include one or more racks 310 on which the pallets 204 may be positioned while the food 201 is being cooked in the wet-steam cookhouse 150. The truck 140, racks 310, and/or pallet 204 are sized and/or dimensioned to sufficiently accommodate a desired amount of food 201, as well as a desired size and/or shape of food 201. In some examples, the racks 310 may be selectively positioned to be at a desired height or elevation. For example, the racks 310 may be spaced at least 10 inches from each other to accommodate larger packages (e.g., 15 pound packs). In this manner, the truck 140 may ensure that the food 201 has adequate exposure all around while in the wet-steam cookhouse 150.

The truck 140 is moved to the wet-steam cookhouse 150 for cooking the food 201 at operation 5. The wet-steam cookhouse 150 may provide for low and slow cooking (e.g., at a temperature between 80 and 212° Fahrenheit for a period between 2 and 9 hours) while the food 201 is therein. For example, the wet-steam cookhouse 150 may be heated with saturated steam to create a steam-based cooking medium in the wet-steam cookhouse 150 to immerse the food 201 in the steam-based cooking medium to achieve fresh sous vide cooking. The steam-based cooking medium may have a relative humidity of 100%. The low and slow cooking provides a tender product that is safe, flavorful, and nutritious.

The food 201 may then be moved to the blast chiller 160 for rapidly chilling the food 201 at operation 6 before pack-off and labelling. The blast chiller 160 may feature a continuous chill process that allows for greater heat reduction at a uniform rate, resulting in faster chill times, higher yields, and greater product uniformity while achieving greater energy savings. In some examples, the blast chiller 160 includes an evaporator coil configured to allow for faster chilling at higher refrigerant temperatures. For example, the food 210 may be chilled from 130 degrees Fahrenheit to a desired 40 degrees Fahrenheit in less than 6 hours. Additionally or alternatively, the blast chiller 160 may include one or more variable speed fans that allow the food 201 to be chilled in a uniform and sanitary manner. For example, the variable speed fans may first run at one speed and then increase to a higher speed when a desired moisture removal is nearly complete. An example blast chiller 160 is a MARLEN Blast Chill Cell. (MARLEN is a registered trademark owned by Marlen International, Inc. in Riverside, Mo.).

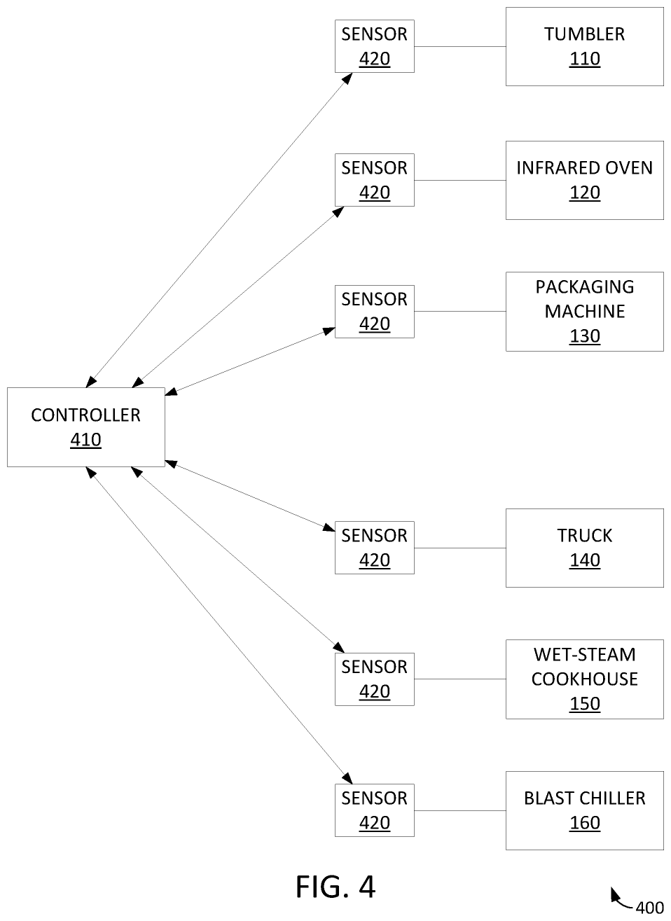

In some examples, the system 100 may include one or more control systems 400 for controlling the operation of the system 100 so that the food 201 is cooked to a desired level at a desired rate so as to achieve the advantages of fresh sous vide cooking. FIG. 4 shows an example control system 400 including a controller 410 and one or more sensors 420 configured to measure and/or detect one or more process parameters. In some examples, the controller 410 may be used to control at least one process parameter at the tumbler 110, infrared oven 120, packaging machine 130, truck 140, wet-steam cookhouse 150, and/or blast chiller 160. Example process parameters may include, without limitation, time, temperature, time, humidity, and/or flow rate. The controller 410 and sensors 420 may be connected by hard wiring, radio frequency, and/or other wireless transmission means that allows information to be communicated therebetween.

To facilitate automating at least a portion of the fresh sous vide process, the controller 410 may receive one or more process parameters as input from one or more sensors 420 so that the controller 410 is aware of the process parameters. The controller 410 may monitor the process parameters to determine whether they are within a predetermined operational range or if they satisfy a predetermined operational threshold and control the tumbler 110, infrared oven 120, packaging machine 130, truck 140, wet-steam cookhouse 150, and/or blast chiller 160 based on the process parameters. For example, the controller 410 may control the tumbler 110, infrared oven 120, packaging machine 130, truck 140, wet-steam cookhouse 150, and/or blast chiller 160 according to applicable food health and safety regulations, such as the FDA's Hazard Analysis and Critical Control Points (HACCP) plans and principles, as well as USDA regulations. In this manner, the fresh sous vide process may be used to kill or eliminate pathogenic microorganisms and/or other bacteria that may be present on and/or in food products, such as Escherichia coli, Salmonella spp., Listeria monocytogenes, Staphylococcus aureus, Clostridium perfringens, Shigella spp., Pseudomonas spp., Enterobacter spp., Klebsiella spp., and yeast.

For example, the controller 410 may receive input from one or more sensors 420 associated with the infrared oven 120 to monitor a cook time, temperature (e.g., at the exterior of the food 201), and/or other process parameters associated with the food 201 and/or infrared oven 120 and determine whether to adjust the infrared oven 120 and/or remove the food 201 from the infrared oven 120 based on the process parameters.

For another example, the controller 410 may receive input from one or more sensors 420 associated with the packaging machine 130 and/or truck 140 to monitor a presence, position, fill level, capacity, seal seam, flow rate, and/or other process parameters associated with the food 201, packages 203, pallets 204, racks 310, truck 140, and/or packaging machine 130 to determine whether to adjust the packaging machine 130 and/or truck 140 based on the process parameters.

For yet another example, the controller 410 may receive input from one or more sensors 420 associated with the wet-steam cookhouse 150 to monitor a cook time, temperature, humidity, air flow rate, and/or other process parameters associated with the food 201 and/or wet-steam cookhouse 150 to determine whether to adjust the wet-steam cookhouse 150 and/or remove the food 201 from the wet-steam cookhouse 150 based on the process parameters. In some examples, control software may be used to fresh sous vide cook the food 201 inside the wet-steam cookhouse 150 to a desired temperature and/or doneness that ensures food safety and/or food quality.

For yet another example, the controller 410 may receive input from one or more sensors 420 associated with the blast chiller 160 to monitor a chill time, temperature, humidity, air flow rate, and/or other process parameters associated with the food 201 and/or blast chiller 160 to determine whether to adjust the blast chiller 160 and/or remove the food 201 from the blast chiller 160 based on the process parameters. In some examples, control software may be used to rapidly chill the food 201 inside the blast chiller 160 and ensure that the food 201 does not reach freezing temperatures, preserving product quality attributes of “fresh, never frozen” and meeting all food safety requirements.

Rather than automatically adjusting the tumbler 110, infrared oven 120, packaging machine 130, truck 140, wet-steam cookhouse 150, and/or blast chiller 160, the controller 410 may instead alert one or more operators. In some examples, the controller 410 may suggest adjustments to be made to the process parameters, which the operator can decide to implement.

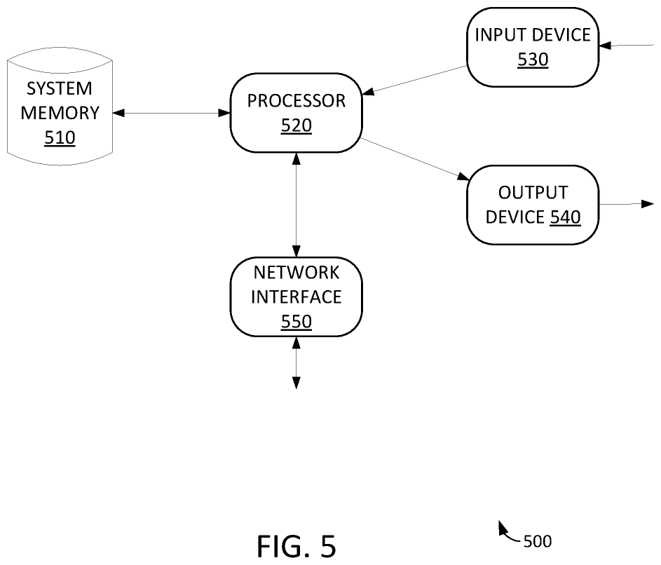

FIG. 5 shows an example computing system 500 configured to perform one or more computing operations. While some examples of the disclosure are illustrated and described herein with reference to the computing system 500 being included in the controller 410 (shown in FIG. 4), aspects of the disclosure are operable with any computing system that executes instructions to implement the operations and functionality associated with the computing system 500. The computing system 500 shows only one example of a computing environment for performing one or more computing operations and is not intended to suggest any limitation as to the scope of use or functionality of the disclosure.

The computing system 500 includes a system memory 510 (e.g., computer storage media) and a processor 520 coupled to the system memory 510. The system memory 510 can store an operating system that controls or allocates resources of the computing system 500. In some examples, the system memory 510 and processor 520 are coupled via a bus that enables data to be transferred therebetween. As used herein, a “memory” can include non-volatile memory and/or volatile memory. Non-volatile memory can include read-only memory (ROM), programmable ROM (PROM), erasable PROM (EPROM), electrically erasable PROM (EEPROM), solid-state drives, and/or disks. Volatile memory can include random-access memory (RAM), static RAM (SRAM), dynamic RAM (DRAM), synchronous DRAM (SDRAM), and/or double data rate SDRAM (DDR SDRAM).

The system memory 510 includes one or more computer-readable media that allow information, such as the computer-executable instructions and other data, to be stored and/or retrieved by the processor 520. For example, the system memory 510 may include computer storage media in the form of read-only memory (ROM), random-access memory (RAM), magnetic tape, a floppy disk, a hard disk, a compact disc (CD), a digital versatile disc (DVD), a flash drive, a memory card, or any other medium that may be used to store desired information that may be accessed by the processor 520. By way of example, and not limitation, computer-readable media may include computer storage media and communication media. Computer storage media are tangible and mutually exclusive to communication media. Computer storage media are implemented in hardware and exclude carrier waves and propagated signals. That is, computer storage media for purposes of this disclosure are not signals per se.

In some examples, the system memory 510 stores data associated with food 201 (e.g., cook times and temperatures) and computer-executable instructions, and the processor 520 is programmed or configured to execute the computer-executable instructions for implementing and/or managing aspects of the disclosure using, for example, the controller 410. The processor 520 may execute the computer-executable instructions to control the system 100 including aspects related to searing food using infrared radiation, positioning the food in a water-impermeable package, vacuum sealing the water-impermeable package with the food positioned therein, and positioning the vacuum-packaged food in a wet-steam cookhouse to fresh sous vide cook the food. Thus, the computing system 500 is capable of controlling the system 100 and the fresh sous vide process performed by the system 100 to provide a desired fresh sous vide cooking environment.

As used herein, a “processor” processes signals and performs general computing and arithmetic functions. Signals processed by the processor 520 can include digital signals, data signals, computer instructions, processor instructions, messages, a bit, a bit stream, or other means that can be received, transmitted and/or detected. The processor 520 may include one or more processing units (e.g., in a multi-core configuration) to execute various functions. Although the processor 520 is shown separate from the system memory 510, examples of the disclosure contemplate that the system memory 510 may be onboard the processor 520, such as in some embedded systems.

A user or operator may enter commands and other input into the computing system 500 through one or more input devices 530 coupled to the processor 520. The input devices 530 are configured to receive information. Example input device 530 include, without limitation, a pointing device (e.g., mouse, trackball, touch pad, joystick), a keyboard, a game pad, a controller, a microphone, a camera, a gyroscope, an accelerometer, a position detector, and an electronic digitizer (e.g., on a touchscreen). Information, such as text, images, video, audio, and the like, may be presented to a user via one or more output devices 540 coupled to the processor 520. The output devices 540 are configured to convey information, images, sounds, smells, etc. to the user 112. Example output devices 540 include, without limitation, a monitor, a projector, a printer, a speaker, a vibrating component. In some examples, an output device 540 is integrated with an input device 530 (e.g., a capacitive touch-screen panel, a controller including a vibrating component).

One or more network interfaces 550 may be used to operate the computing system 500 in a networked environment using one or more logical connections. Logical connections include, for example, local area networks, wide area networks, and the Internet. The network interfaces 550 allow the processor 520, for example, to convey information to and/or receive information from one or more remote devices, such as another computing system or one or more remote computer storage media. Computer communication between computing systems can be a network transfer, a file transfer, an applet transfer, an email, a hypertext transfer protocol (HTTP) transfer, and so on. A computer communication can occur across a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others. Network interfaces 550 may include a network adapter, such as a wired or wireless network adapter or a wireless data transceiver.

Example systems and methods for providing an fresh sous vide cooking experience are described herein and illustrated in the accompanying drawings. Various examples may be implemented as instructions stored on a non-transitory machine-readable storage medium, such as a volatile or non-volatile memory, which may be read and executed by at least one processor to perform the operations described in detail herein. A machine-readable storage medium may include any mechanism for storing information in a form readable by a machine, such as a personal or laptop computer, a server, or other computing device. Thus, a non-transitory machine-readable storage medium excludes transitory signals but may include both volatile and non-volatile memories.

Examples described herein use a combination of various technologies, including: infrared oven technology (e.g., to sear animal proteins), vacuum packaging technology (e.g., to prevent product oxidation), steam cooking technology, and/or blast chilling technology to produce safe and high-quality food products that are ready-to-eat (RTE) or ready-to-heat (RTH). The freshly-cooked food products made using the technologies described herein are superior in taste, texture, and appearance to conventional frozen products. The batch process allows for more flexibility in cook time and temperatures (e.g., longer cook-time for larger muscle cuts of beef and/or pork). In this manner, the food can be cooked at specific cooking conditions, which can enhance product attributes of lower-quality muscle cuts and yield lower-cost finished products. The batch process also allows for larger packages (e.g., 15 pounds), which leads to greater output, combo packing, less waste in packaging, better yields, and ease in operations for prepared meal kit assemblers.

Various foods can be cooked using the sous vide process, including meat (e.g., poultry, beef, pork), seafood, vegetables, and plant-based products. The food product is delivered to the end user in the same package it was cooked in. This enables the nutrients to be continually held within the package and also reduces a risk of food-borne pathogens per USDA guidelines. The cooking methods and/or systems described herein enable producing an end product has a clean fresh flavor with no off aroma or off flavor from chemical ingredients or flavorings, and optimal texture with no ice crystal formation that can disrupt the muscle structure. Cooking the food in the same package also greatly reduces end-use recall risk by, receiving at least a 7-log reduction in food-borne pathogens. Examples described herein improve food safety and quality of animal proteins, seafood, vegetables, and plant-based products while extending the refrigerated shelf-life. This also reduces labor and/or improves cook or heat-up times for foodservice operations.

The examples described herein use valuable resources, such as raw materials and water, in an efficient manner. For example, the sous vide process reduces overall waste while producing a high finished product yield and utilizes significantly less water (e.g., about 70-90% less) than conventional sous vide processes.

It should be appreciated by those skilled in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

This written description uses examples to disclose aspects of the disclosure and also to enable a person skilled in the art to practice the aspects, including making or using the above-described systems and executing or performing the above-described methods. Having described aspects of the disclosure in terms of various examples with their associated operations, it will be apparent that modifications and variations are possible without departing from the scope of the disclosure as defined in the appended claims. That is, aspects of the disclosure are not limited to the specific examples described herein, and all matter contained in the above description and shown in the accompanying drawings shall be interpreted as illustrative and not in a limiting sense. For example, the examples described herein may be implemented and utilized in connection with many other applications.

Components of the systems and/or operations of the methods described herein may be utilized independently and separately from other components and/or operations described herein. Moreover, the methods described herein may include additional or fewer operations than those disclosed, and the order of execution or performance of the operations described herein is not essential unless otherwise specified. That is, the operations may be executed or performed in any order, unless otherwise specified, and it is contemplated that executing or performing a particular operation before, contemporaneously with, or after another operation is within the scope of the disclosure. Although specific features of various examples of the disclosure may be shown in some drawings and not in others, this is for convenience only. In accordance with the principles of the disclosure, any feature of a drawing may be referenced and/or claimed in combination with any feature of any other drawing.

When introducing elements of the present disclosure or the one or more embodiment(s) thereof, the articles “a”, “an”, “the” and “said” are intended to mean that there are one or more of the elements. References to an “embodiment” or an “example” of the present disclosure are not intended to be interpreted as excluding the existence of additional embodiments or examples that also incorporate the recited features. The terms “comprising”, “including” and “having” are intended to be inclusive and mean that there may be additional elements other than the listed elements. The phrase “one or more of the following: A, B, and C” means “at least one of A and/or at least one of B and/or at least one of C.”

In view of the above, it will be seen that the several objects of the disclosure are achieved and other advantageous results attained. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A commercial-scale fresh sous vide cooking method comprising:
searing food using infrared radiation;
positioning the food in a water-impermeable package;
vacuum sealing the water-impermeable package with the food positioned therein; and
positioning the vacuum-packaged food in a wet-steam cookhouse to fresh sous vide cook the food.

2. The method according to claim 1, wherein the food has not been frozen.

3. The method according to claim 1, further comprising tumbling the food in a tumbler before searing the food.

4. The method according to claim 3, further comprising:
monitoring one or more parameters associated with the tumbler; and
adjusting the tumbler based on the one or more parameters.

5. The method according to claim 1, further comprising:
monitoring one or more parameters associated with an infrared oven emitting the infrared radiation; and
adjusting the infrared oven based on the one or more parameters.

6. The method according to claim 1, further comprising portioning the food in batches with other like foods.

7. The method according to claim 1, further comprising positioning the vacuum-packaged food on a pallet, wherein the vacuum-packaged food is positioned in the wet-steam cookhouse by moving the pallet into the wet-steam cookhouse.

8. The method according to claim 7, further comprising selectively positioning the pallet at a desired elevation.

9. The method according to claim 1, further comprising:
monitoring one or more parameters associated with a packaging machine vacuum sealing the water-impermeable package; and
adjusting the packaging machine based on the one or more parameters.

10. The method according to claim 1, further comprising:
monitoring one or more parameters associated with the wet-steam cookhouse; and
adjusting the wet-steam cookhouse based on the one or more parameters.

11. The method according to claim 1, further comprising rapidly chilling the food using a blast chiller.

12. The method according to claim 11, further comprising:
monitoring one or more parameters associated with the blast chiller; and
adjusting the blast chiller based on the one or more parameters.

13. A system for fresh sous vide cooking of food on a commercial scale, comprising:
an infrared oven configured to emit infrared radiation for searing the food;
a packaging machine configured to position the food in a water-impermeable package and vacuum seam the water-impermeable package with the food positioned therein;
a wet-steam cookhouse configured to fresh sous vide cook the food; and
a control system for controlling one or more parameters associated with one or more of the infrared oven, the packaging machine, or the wet-steam cookhouse.

14. The system according to claim 13, further comprising a tumbler configured to tumble the food before the food is seared.

15. The system according to claim 14, wherein the control system is configured to control one or more parameters associated with the tumbler.

16. The system according to claim 13, further comprising a truck configured to support the food while the food is in the wet-steam cookhouse.

17. The system according to claim 16, wherein the truck includes a plurality of racks.

18. The system according to claim 13, further comprising a blast chiller configured to rapidly chill the food.

19. The system according to claim 18, wherein the control system is configured to control one or more parameters associated with the blast chiller.

20. A control system for use in controlling a fresh sous vide cooking system, comprising:
one or more sensors that detect one or more parameters associated with the fresh sous vide cooking system; and
a controller that communicates with the one or more sensors to determine whether the one or more parameters satisfy a predetermined operational threshold and operate one or more of a tumbler, an infrared oven, a packaging machine, a truck, a wet-steam cookhouse, or a blast chiller based on the determination.
